(19) United States
(12) Patent Application Publication
(10) Pub. No.: US 2006/0061100 A1
(43) Pub. Date: Mar. 23, 2006

(54) Connector assembly for corrosive gas supply pipe

(75) Inventors: Do-In Choi, Yongin-si (KR); Young-Seok Kim, Seongnam-si (KR); Yun-Je Oh, Yongin-si (KR); Jong-Hun Lee, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/202,499

(22) Filed: Aug. 12, 2005

(30) Foreign Application Priority Data
Nov. 30, 2004 (KR) 2004-99435
Sep. 21, 2004 (KR) 2004-75528

(51) Int. Cl. F16L 17/00

(52) U.S. Cl. 285/345

(57) ABSTRACT

A connector assembly for coupling a corrosive gas supply pipe with a glass tube in an apparatus for fabricating an optical fiber preform using vapor deposition is disclosed. The connector assembly includes a first connector formed on an inner periphery thereof with a threaded portion, a second connector having a stepped surface on an inner surface and formed on an outer periphery with a threaded portion threadedly engaged with the first connector, an O-ring installed in the first connector and in close contact with the stepped surface when the second connector is threadedly engaged with the first connector, and resilient means for urging the O-ring against the stepped surface. The connector assembly consistently applies a resilient force to the O-ring functioning as a seal between the first and second connectors. For a long-running operation, even though the O-ring is cured, the fitting maintains a consistent sealing state to prevent metal material from being oxidized by the corrosive gas. As a result, fine oxidized metal particulars do not infiltrate into the gas supply pipe to prevent the optical fiber preform from deteriorating.

### CLAIM OF PRIORITY

This application claims priority to an application entitled “connector assembly for corrosive gas supply pipe,” filed in the Korean Intellectual Property Office on Nov. 30, 2004 and assigned Serial No. 2004-99435, the contents of which are hereby incorporated by reference.

### BACKGROUND OF THE INVENTION

1. Field of the Invention

The present invention relates to an apparatus for fabricating an optical fiber preform using a vapor deposition method and, more particularly, to a connector assembly for connecting a corrosive gas supply pipe with a glass tube.

2. Description of the Related Art

An optical fiber preform is typically fabricated by vapor deposition or sol-gel processing. In the sol-gel processing, fluid raw material is put in a mold to transform the fluid into a gel state and then sintered in a sintering furnace to produce silica glass. Since the sol-gel processing is generally performed at a low temperature, fabrication costs are low, and the composition of a target substance is easily controlled.

The vapor deposition is divided into modified chemical vapor deposition (MCVD), vapor axial deposition (VAD), and outside vapor deposition (OVD). Since the vapor deposition fabricates a solid optical fiber preform using vapor-phase reaction at a high temperature of about 1,800° C. for a long time, its productivity is low and requires an expensive fabricating apparatus. However, this technique ensures a high-quality optical fiber preform.

In the vapor deposition techniques, a deposition furnace for depositing the optical fiber preform is supplied with a corrosive gas to evaporate the raw substance through a glass tube and a gas supply pipe.

FIG. 1 is a partially cutaway view of a conventional connector assembly 100 showing a corrosive gas supply pipe. As shown, the conventional connector assembly 100 includes a first connector 101, a second connector 102, a ferrule 113 and an O-ring 115 for air-tightening a connecting portion between a glass tube 111 and a gas supply pipe 12 1.

The first connector 101 is placed on an outer periphery of one end of the glass tube 111 and is formed with a threaded portion on an inner periphery thereof. The ferrule 113 is installed inside the first connector 101 to tightly abut the first connector 101 against the glass tube 111, and the O-ring 115 is installed to one end of the ferrule 113. The threaded portion of the first connector 101 faces an outer periphery of the ferrule 113, with the threaded portion being spaced apart from the outer periphery.

The second connector 102 is placed on one end of the gas supply pipe 121 and formed with a threaded portion on an outer periphery thereof. The second connector is threadedly engaged with the threaded portion of the first connector 101. The second connector 102 is provided on an inner periphery thereof with a stepped surface to support the O-ring 115 as the first connector 101 is threadedly engaged with the second connector 102.

FIGS. 2a and 2b show ante-coupling and post-coupling of the connector assembly 100 shown in FIG. 1, respectively.

Referring to FIG. 2a, even though the first connector 101 is threadedly engaged with the second connector 102, if the connectors are not fully fastened, the O-ring 115 is maintained in the shape of a circular cross section. In this case, an outer periphery of the O-ring 115 does not sufficiently abut against the outer periphery of the glass tube 111, the ferrule 115, and the stepped surface of the second connector 102, thus not providing a fully airtight function.

Referring to FIG. 2b, when the first connector 101 is fully threadedly engaged with the second connector 102, the O-ring 115 is elastically deformed which in turn increases the contact area with the ferrule 115 and the stepped surface of the second connector 102. Accordingly, the O-ring 115 performs a reliably airtight function in the state where the first connector 101 is fully engaged with the second connector 102.

For a long-running operation, however, the material of the O-ring is cured and thus the elastic force is reduced. As such, the contact area between components, such as the outer periphery of the glass tube and the ferrule, is reduced, such that the airtight function is not effectively achieved. Further, since the corrosive gas passing through the gas supply pipe and the glass tube is a hot gas, the cure of the O-ring is further accelerated which can cause the corrosive gas to leak and thus induce the gas supply pipe to oxidize. Furthermore, it is possible that oxidized fine metal particulars that flow in the gas supply pipe may adhere to an inner wall of the glass tube, thereby causing the deterioration of the optical fiber preform.

### SUMMARY OF THE INVENTION

Accordingly, the present invention has been made to solve the above-mentioned problems contained in the prior art and provides additional advantages, by providing a connector assembly for a corrosive gas supply pipe capable of steadily maintaining contactness of an O-ring against the gas supply pipe and a connector even when the O-ring is exposed to a high temperature for a long time.

One aspect of the present invention is to provide a connector assembly for a corrosive gas supply pipe capable of steadily maintaining contactness of an O-ring against the gas supply pipe and a connector, thereby preventing leakage of a corrosive gas and oxidization of metal material of the gas supply pipe.

Another aspect of the present invention is to provide a connector assembly for coupling a corrosive gas supply pipe with a glass tube in an apparatus for fabricating an optical fiber preform using vapor deposition which includes: a first connector formed on an inner periphery thereof with a threaded portion; a second connector having a stepped surface on an inner surface, and formed on an outer periphery with a threaded portion threadedly engaged with the first connector; an O-ring installed in the first connector, and closely contacted with the stepped surface when the second connector is threadedly engaged with the first connector; and resilient means for urging the O-ring against the stepped surface.

### BRIEF DESCRIPTION OF THE DRAWINGS

The above features and advantages of the present invention will be more apparent from the following detailed description taken in conjunction with the accompanying drawings, in which:

FIG. 1 is a partially cutaway view of a conventional connector assembly for a corrosive gas supply pipe;

FIGS. 2a and 2b are views depicting ante-coupling and post-coupling of the connector assembly shown in FIG. 1;

FIG. 3 is a side elevational view, partly in cross section, of a connector assembly for a corrosive gas supply pipe according to an embodiment of the present invention; and

FIG. 4 is a view depicting a fully fastened state of the connector assembly shown in FIG. 3.

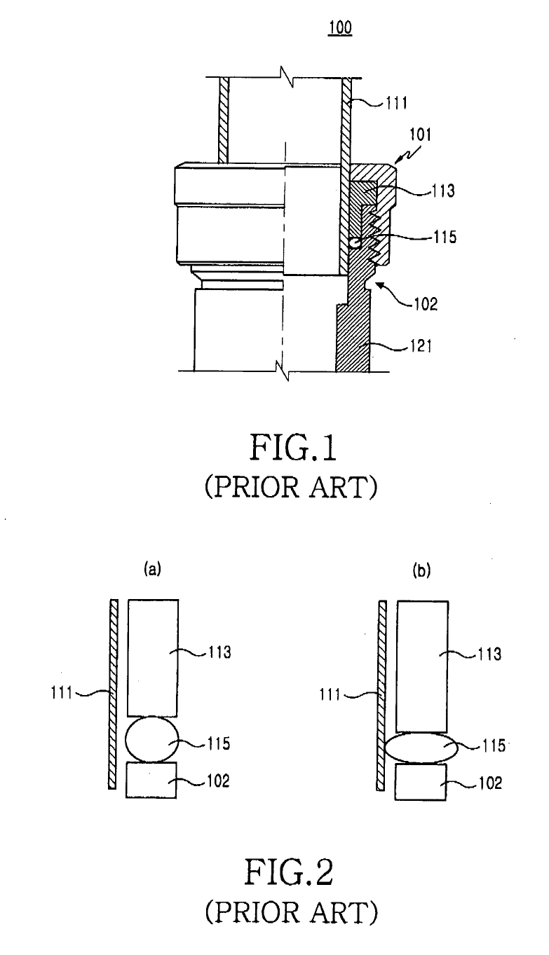

### DETAILED DESCRIPTION

Hereinafter, embodiments of the present invention will be described with reference to the accompanying drawings. In the following description, the same elements will be designated by the same reference numerals although they are shown in different drawings.

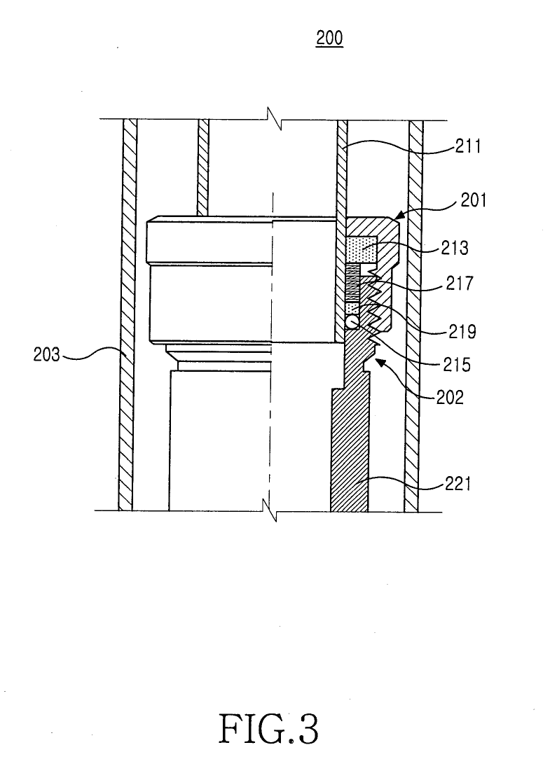

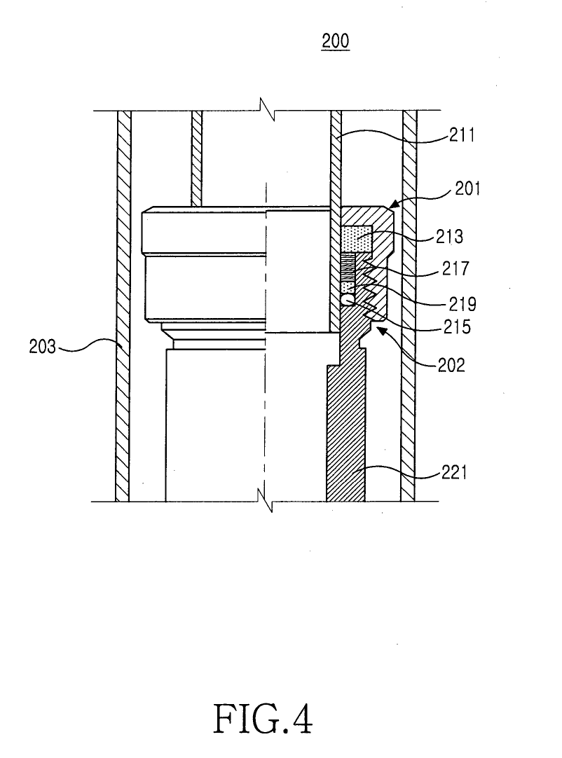

FIG. 3 is a side view of a connector assembly 200 for a corrosive gas supply pipe according to an embodiment of the present invention. FIG. 4 is a view depicting a fully fastened state of the connector assembly 200 shown in FIG. 3.

Referring to FIGS. 3 and 4, the connector assembly 200 according to the present invention includes a first connector 201, a second connector 202, at least one ferrules 213 and 219, an O-ring 215, and a resilient means 217, for air-tightening a connecting portion between a glass tube 211 and a gas supply pipe 221.

The first connector 201 is placed on an outer periphery of one end of the glass tube 211, and is formed with a threaded portion on an inner periphery thereof. The ferrule 213 is installed inside the first connector 201 to tightly abut the first connector 201 against the glass tube 211, and the O-ring 215 is installed to one end of the ferrule 213. The resilient means 217 may be selected from a compression spring, an air spring, a spring washer, etc. Alternatively, another ferrule 219 may be installed between the resilient means 217 and the O-ring 215 to evenly apply a resilient force of resilient means 217 to the O-ring 215 in a radial direction. As a result, the resilient means 217 is supported at both ends thereof by the ferrules 213 and 219, thereby providing the O-ring 215 with the resilient force. Note that the outer periphery of the glass tube 211 may be polished to improve the contactness of the O-ring 215 against the glass tube 211.

The second connector 202 is placed at one end of the gas supply pipe 221, and is formed with a threaded portion on an outer periphery thereof and threadedly engaged with the threaded portion of the first connector 201. When the second connector 202 is engaged with the first connector 201, the second connector 202 is interposed between the inner periphery of the first connector 201 and the resilient means 217. The second connector 202 is provided on an inner periphery thereof with a stepped surface to support the O-ring 215 as the first connector 201 is threadedly engaged with the second connector 202.

As shown in FIG. 3, even though the first connector 201 is threadedly engaged with the second connector 202, if the connectors are not fully fastened, the O-ring 215 is maintained in a shape of an elliptical cross section, a diameter of which increases in the same direction as the acting direction of the resilient means 217. In this case, an outer periphery of the O-ring 215 does not sufficiently abut against the outer periphery of the glass tube 211, the ferrule 215, and the stepped surface of the second connector 202, thus unable to provide a fully airtight function.

As shown in FIG. 4, when the first connector 201 is fully threadedly engaged with the second connector 202, the resilient means 217 are compressed to accumulate the resilient force of the resilient means 217, and the O-ring 215 is elastically deformed. As a result, an area coming in contact with the ferrule 215 and the stepped surface of the second connector 202 is enlarged. Accordingly, the O-ring 215 performs a reliably airtight function in the state where the first connector 201 is fully engaged with the second connector 202.

At that time, the resilient force accumulated in the resilient means 217 causes the O-ring 215 to consistently contact against the stepped surface of the second connector 202. Even though the O-ring 215 is used for a long time or exposed to the high temperature, the resilient means 217 may consistently apply the resilient force to the O-ring 215, such that the O-ring can sufficiently and consistently abut against the outer periphery of the glass tube 211, the ferrule 215, and the stepped surface of the second connector 202.

The connector assembly 200 further includes a protective tube 203 for cooling the first and second connectors 201 and 202 and for protecting the gas supply pipe 221 from being oxidized due to the contact between leaked corrosive gas and a moisture.

The protective tube 203 is adapted to enclose the first and second connectors 201 and 202 and extend along a longitudinal direction of the gas supply pipe 203 and the glass tube 211. A moisture barrier gas, preferably, nitrogen gas, flows in the protective tube 203.

The moisture barrier gas in the protective tube flows around the first and second connectors 201 and 202 to refrigerate the first and second connectors 201 and 202 and to prevent the first and second connectors 201 and 202 and the gas supply pipe 221 from being oxidized when the corrosive gas is leaked.

As described above, the connector assembly according to the present invention includes the resilient means for consistently applying the resilient force to the O-ring functioning as a seal between the first and second connectors. For a long-running operation, even though the O-ring is cured, the fitting of the present invention can maintain a consistent sealing state. As such, outflow of the corrosive gas is blocked, thereby preventing the metal material from being oxidized by the corrosive gas. As a result, fine oxidized metal particulars do not infiltrate into the gas supply pipe to prevent the optical fiber preform from deteriorating. Also, the connector assembly of the present invention includes the protective tube for enclosing the first and second connectors. The moisture barrier gas flows to protect the metal material, such as the first and second connectors and the gas supply pipe, from being oxidized by the contact between leaked corrosive gas and the moisture. Further, the moisture barrier gas flowing in the protective tube functions to refrigerate the first and second connectors, thereby preventing the O-ring from being prematurely cured due to the exposure of the O-ring to the high temperature.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A connector assembly for coupling a corrosive gas supply pipe and a glass tube, the connector assembly comprising:
a first connector having a threaded portion formed on an inner periphery thereof;
a second connector having a stepped surface on an inter surface thereof and a threaded portion formed on an outer periphery thereof, the second coupler being threadedly engaged with the first connector;
an O-ring installed in the first connector to closely contact with the stepped surface of the second connector as the second connector threadedly engages with the first connector; and
resilient means for urging the O-ring against the stepped surface of the second connector.

2. The connector assembly as claimed in claim 1, wherein the resilient means is one of a compression spring, an air spring, and a spring washer.

3. The connector assembly as claimed in claim 1, further comprising a ferrule interposed between the O-ring and the resilient means for transferring a resilient force from the resilient means to the O-ring.

4. The connector assembly as claimed in claim 1, wherein the first connector is coupled to the glass tube, and the second connector is coupled to the gas supply pipe.

5. The connector assembly as claimed in claim 1, wherein one end of the resilient means is supported by an inner end of the first connector.

6. The connector assembly as claimed in claim 5, further comprising a ferrule interposed between the O-ring and the inner end of the first connector.

7. The connector assembly as claimed in claim 1, further comprising a protective tube for enclosing the glass tube, the gas supply pipe, and the first connector threadedly engaged with the second connector, wherein a moisture barrier gas is supplied into the protective tube such that the corrosive gas leaked from a coupled portion between the first and second connectors does not come in contact with external moisture.

8. The connector assembly as claimed in claim 7, wherein the moisture barrier gas refrigerates the first and second connectors.

9. The connector assembly as claimed in claim 7, wherein the moisture barrier gas is a nitrogen gas.

10. The connector assembly as claimed in claim 1, wherein an outer periphery of the glass tube is polished to improve contactness of the glass tube against the O-ring.
